(19) United States
(12) Patent Application Publication
(10) Pub. No.: US 2015/0109532 A1
(43) Pub. Date: Apr. 23, 2015

(54) CUSTOMIZING MOBILE MEDIA CAPTIONING BASED ON MOBILE MEDIA RENDERING

(71) Applicant: Google Inc., Mountain View, CA (US)

(72) Inventors: Justin Lewis, Marina del Rey, CA (US); Ruxandra Georgiana Paun, Santa Monica, CA (US)

(73) Assignee: Google Inc., Mountain View, CA (US)

(21) Appl. No.: 14/061,231

(22) Filed: Oct. 23, 2013

(51) Int. Cl. H04N 5/445

(52) U.S. Cl. CPC H04N 5/445
USPC 348/564

(57) ABSTRACT

A processing device determines a rendering mode for a media item being presented in a user interface on a mobile device. The rendering mode is one of multiple rendering modes. The processing device determines a set of captioning parameters that corresponds to the rendering mode of the media item and provides captioning for the media item in the user interface based on the set of captioning parameters that corresponds to the rendering mode.

### TECHNICAL FIELD

The present disclosure relates to media captioning and, more particularly, to a technique of customizing mobile media captioning based on mobile media rendering.

### BACKGROUND

Traditionally, closed captioning subtitles are provided in videos by encoding the subtitles in the video itself. Conventional solutions may include the subtitles in the pixel scheme of the video, which generally results in the subtitles having static characteristics (e.g., position, font, font size) during the entire time that the video is being played. In another example, some traditional solutions draw the subtitles on top of the video using a third party API (application program interface). The third party API is independent of the media application that is rendering the video, and thus, unaware of how the video is being rendered. The third party API generally places the subtitles in one location on top of the video. Traditional solutions provide subtitles that are generally immobile in position and have fixed font characteristics. Conventional subtitle solutions may impede a user's experience when the user is watching a video. For example, when a user watches a video on a mobile device in a horizontal orientation, the subtitles may be a large font size and may appear on the lower portion of the video. When the user changes the mobile device to a vertical orientation, the mobile device may change the size of the video, such that the video is much smaller. However, traditional subtitle solutions generally continue to display the subtitles using the large font size. When the video is smaller in the vertical position users typically find that the large font size is too large and make the subtitles incomprehensible.

### SUMMARY

The following presents a simplified summary of various aspects of this disclosure in order to provide a basic understanding of such aspects. This summary is not an extensive overview of all contemplated aspects, and is intended to neither identify key or critical elements nor delineate the scope of such aspects. Its purpose is to present some concepts of this disclosure in a simplified form as a prelude to the more detailed description that is presented later.

A method and apparatus to provide custom mobile media captioning based on mobile media rendering is described. The method includes determining a rendering mode for a media item being presented in a user interface on a mobile device. The rendering mode is one of multiple rendering modes. The method includes determining a set of captioning parameters that corresponds to the rendering mode of the media item and providing captioning for the media item in the user interface based on the set of captioning parameters that corresponds to the rendering mode.

In one implementation, the captioning parameters include font of the captioning, font size of the captioning, kerning of the captioning, position of the captioning, wrapping of the captioning, orientation of the captioning, and/or animation of the captioning. In one implementation, the determining of the rendering mode for the media item includes determining an orientation of the mobile device and determining one or more elements of the user interface on the mobile device. In one implementation, the one or more elements of the user interface includes a portion of the user interface that is presenting the media item, a location in the user interface of the portion, dimensions of the media item that is presented, and/or data pertaining to the media item.

In one implementation, the method further includes determining a change is made to the rendering mode to create a changed rendering mode, determining another one of the plurality of sets of captioning parameters that corresponds to the changed rendering mode, and adjusting the captioning for the media item in the user interface based on the other one of the plurality of sets of captioning parameters that correspond to the rendering mode. In one implementation, the determining of the change includes determining that the mobile device is changed from being in a first orientation to a second orientation and/or receiving user input changing one of the elements of the user interface. In one implementation, the rendering mode includes the mobile device being in a portrait orientation and the media item being presented in a lower portion of a display of the mobile device in the portrait orientation.

In one implementation, a method includes detecting a change in a rendering mode of a media item presented in a user interface on a mobile device. The rendering mode is one of a plurality of rendering modes. The method further includes modifying, in the user interface, captioning for the media item in accordance with the changed rendering mode.

An apparatus to provide custom mobile media captioning based on mobile media rendering is also described. The apparatus includes means for determining a rendering mode for a media item being presented in a user interface on a mobile device. The rendering mode is one of multiple rendering modes. The apparatus includes means for determining a set of captioning parameters that corresponds to the rendering mode of the media item and means for providing captioning for the media item in the user interface based on the set of captioning parameters that corresponds to the rendering mode.

In one implementation, the captioning parameters include font of the captioning, font size of the captioning, kerning of the captioning, position of the captioning, wrapping of the captioning, orientation of the captioning, and/or animation of the captioning. In one implementation, means for determining the rendering mode for the media item includes means for determining an orientation of the mobile device and means for determining one or more elements of the user interface on the mobile device. In one implementation, the one or more elements of the user interface includes a portion of the user interface that is presenting the media item, a location in the user interface of the portion, dimensions of the media item that is presented, and/or data pertaining to the media item.

In one implementation, apparatus includes means for detecting a change in a rendering mode of a media item presented in a user interface on a mobile device. The rendering mode is one of a plurality of rendering modes. The apparatus further includes means for modifying, in the user interface, captioning for the media item in accordance with the changed rendering mode.

In one implementation, the apparatus further includes means for determining a change is made to the rendering mode to create a changed rendering mode, means for determining another one of the plurality of sets of captioning parameters that corresponds to the changed rendering mode, and means for adjusting the captioning for the media item in the user interface based on the other one of the plurality of sets of captioning parameters that correspond to the rendering mode. In one implementation, means for determining the change includes means for determining that the mobile device is changed from being in a first orientation to a second orientation and/or means for receiving user input changing one of the elements of the user interface. In one implementation, the rendering mode includes the mobile device being in a portrait orientation and the media item being presented in a lower portion of a display of the mobile device in the portrait orientation.

In additional implementations, computing devices for performing the operations of the above described implementations are also implemented. Additionally, in implementations of the disclosure, a computer readable storage media may store instructions for performing the operations of the implementations described herein.

### BRIEF DESCRIPTION OF THE DRAWINGS

The present disclosure will be understood more fully from the detailed description given below and from the accompanying drawings of various implementations of the disclosure.

FIG. 1 is a diagram illustrating example media user interfaces providing custom captioning for a media item in accordance with one or more implementations.

FIG. 2 is flow diagram of an implementation of a method providing custom captioning for a media item in a media user interface based the rendering of the media item.

FIG. 3 illustrates exemplary system architecture in which implementations can be implemented.

FIG. 4 is a block diagram of an example computer system that may perform one or more of the operations described herein, in accordance with various implementations.

### DETAILED DESCRIPTION

A system and method for providing custom mobile media captioning based on mobile media rendering is described, according to various implementations. A media consumption document hereinafter refers to a document (e.g., webpage, mobile application document) that is rendered to provide a media user interface (UI) that is presented to a user for presenting (e.g., playing) a media item (e.g., video). For example, when a video has been selected for playing, the media consumption document can be rendered to provide the media UI, which plays the video. Examples of a media item can include, and are not limited to, digital video, digital movies, digital photos, digital music, website content, social media updates, electronic books (ebooks), electronic magazines, digital newspapers, digital audio books, electronic journals, web blogs, real simple syndication (RSS) feeds, electronic comic books, software applications, etc. A media item can be a media item consumed via the Internet and/or via an application. As used herein, “media,” media item,” “online media item,” “digital media,” and “digital media item” can include an electronic file that can be executed or loaded using software, firmware or hardware configured to present the digital media item to an entity. For brevity and simplicity, an online video (also hereinafter referred to as a video) is used as an example of a media item throughout this document.

The user may select to play a video with captioning. Captioning hereinafter refers to closed captioning, subtitling, or any other form of displaying data (e.g., text, characters, symbols, punctuation, pictorial representations, etc.) on a visual display to provide additional information or interpretive information for a media item. For example, captioning can provide a transcription (either verbatim or in edited form) of an audio portion of a video as the corresponding portion of the video has been presented, is being presented, or is to be presented. In another example, captioning can provide user-based comments that relate to a portion of a video that has presented (e.g., played), is being presented, or to be presented.

Implementations of the present disclosure customize the captioning for the media item that is being presented in the media UI based on how the media item is being rendered. For example, if the video is playing while the mobile device is in a portrait (vertical) orientation and is playing using the top third of the display of the mobile device, the captioning may have a small font size and the captioning may be animated. For example, the captioning may be scrolling across the horizontal length of the video. In another example, if the video is playing while the mobile device is in a landscape (horizontal) orientation and is playing using 90% of the display of the mobile device, the captioning may have a large font size and the captioning may not be animated.

Accordingly, contrary to conventional solutions, which display subtitles using fixed captioning characteristics (e.g., font, font size, position) regardless, for example, of whether the video is being rendered using a large portion of a display or a small portion of the display, implementations of the present disclosure dynamically adjust the characteristics of the captioning based on the how the video is being rendered to provide users more comprehensible captioning. For example, the mobile device may initially present a video in a landscape mode using a large (e.g., 95%) portion of the mobile device display. The captioning may be displayed using a large font size. When the user changes the position of the mobile device to a portrait orientation, the video may be scaled down according to the layout that is available in the portrait orientation. Implementations of the present disclosure can dynamically scale the captioning characteristics (e.g., font size, spacing between characters, animation, position, etc.) accordingly to provide comprehensible captioning in the portrait orientation.

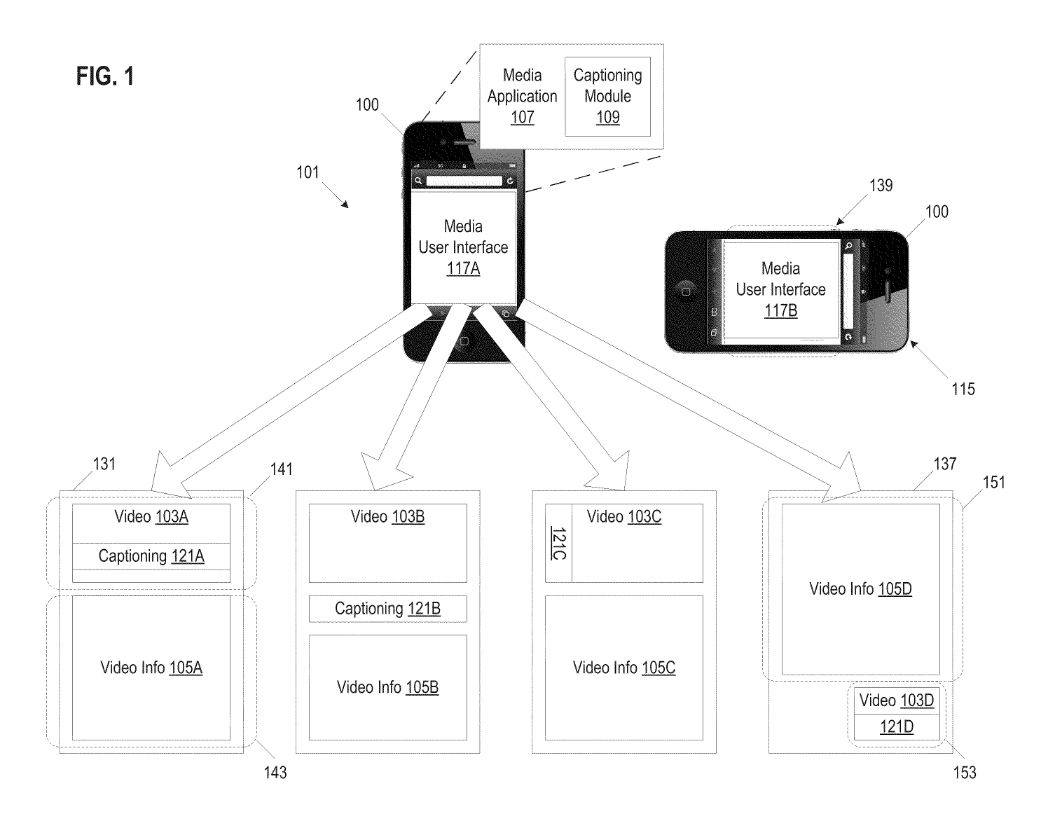

FIG. 1 is a diagram illustrating example media user interfaces (UIs) 117A-B providing custom captioning for a media item in accordance with one implementation of the present disclosure. The mobile device 100 can include a media application 107 to present (e.g., play) videos 103A-D. The media application 107 can be for example, a mobile application, a web application, etc. For example, the media application 107 may be a media player embedded in a webpage that is accessible via a web browser. In another example, the media application is a mobile device application for presenting (e.g., playing) media items (e.g., videos). The media application 107 can include a captioning module 109 to provide custom captioning in the media user interfaces 117A,B based on how the video 103A-D that is being presented is rendered. For example, the captioning module 109 can take into account the orientation 101,115 of the mobile device 100, the portion of the mobile device display that is presenting the video 103A-D, the size of the video 103A-D, etc. A mobile device 100 can be in a portrait orientation 101 or in a landscape mode 115. For example, the mobile device 100 may be in a portrait orientation 101 and can provide a media UI 117A in the portrait orientation 101. In another example, the mobile device 100 may be in a landscape orientation 115 and can provide a media UI 117B in the landscape orientation 115.

The media application 107 can present a media item (e.g., video 103A-D) using one of multiple rendering modes. For example, when the mobile device 100 is in a portrait orientation 101, the media UI 117A can render the video 103A-D using one of multiple rendering modes. Rendering modes 131,137 illustrate various example rendering modes for when the mobile device 100 is in a portrait orientation 101. In another example, when the mobile device 100 is in landscape orientation 115, the media UI 117B can render a video using one of multiple rendering modes. For example, in one rendering mode, the media application 107 can use the entire media UI 117B or a large percentage (e.g., 95%) of the media UI 117B to play the video.

Each of the rendering modes can include one or more elements, such as, and not limited to, the portion (e.g., portion 141,153) of the media UI that is presenting the media item (e.g., video 103A-D), a location in the media UI of the portion, dimensions of the media item that is presented, data (e.g., video info 105A-D) pertaining to the media item, etc.

For example, rendering mode 131 can include a portion 141 (e.g., 30% of the media UI) of the media UI 117A and a corresponding location (e.g., top) in the media UI 117A for the portion 141 that can be used to present video 103A in the portrait orientation 101. The video 103A can have dimensions to appropriately fill the portion 141. The rendering mode 131 can include another portion 143 (e.g., 70% of the media UI) of the media UI 117A and a corresponding location (e.g., bottom) in the media UI 117A for the portion 143 that can be used to provide video information 105A in the portrait orientation 101. Examples of video information 105A-D can include, and are not limited to, a title of the video, a number of views of the video, the time elapsed since the video was uploaded, the time the video was uploaded, the number of likes of the video, the number of recommendations made for the video, the length of the video, a rating of the video, a description of the video, comments, related videos, user input UI elements, etc.

In another example, rendering mode 137 can include a portion 153 (e.g., 15% of the media UI) of the media UI 117A and a corresponding location (e.g., bottom right) in the media UI 117A for the portion 153 that can be used to present video 103D in the portrait orientation 101. The video 103D may have small dimensions to appropriately fill the portion 153. The rendering mode 137 can include another portion 151 (e.g., 70% of the media UI) of the media UI 117A and a corresponding location (e.g., top) in the media UI 117A for the portion 151 that can be used to provide video information 105D in the portrait orientation 101. For example, the video 103D may be scaled down to smaller dimensions to fit a smaller portion of the mobile device 100 display to allow a user to use a larger portion (e.g., 70%) of the display for scrolling through the video information 105D.

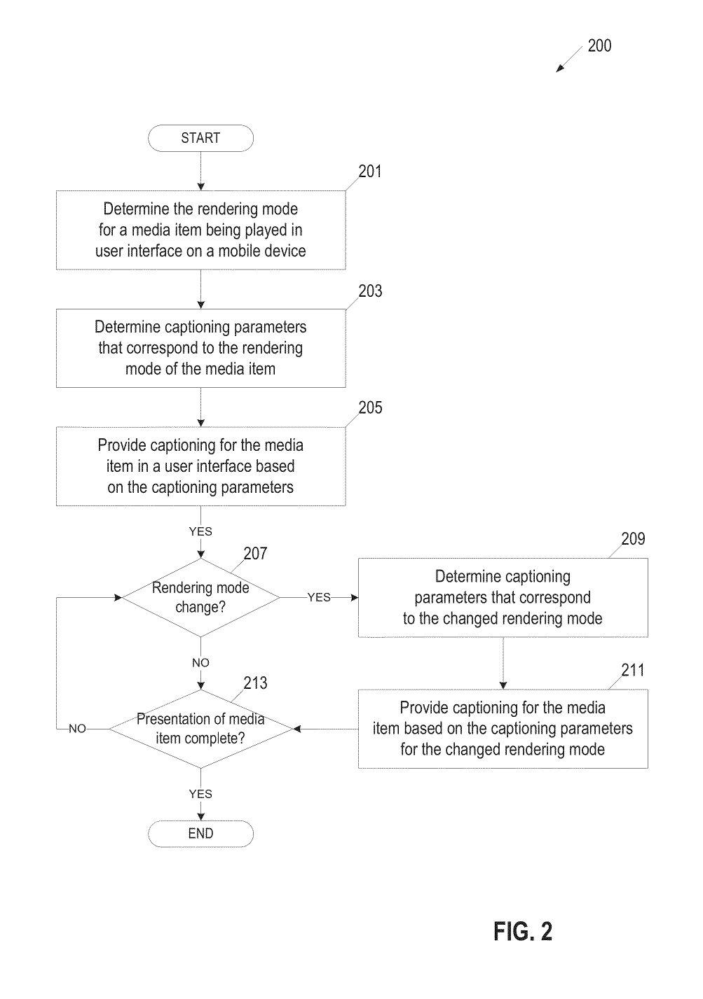

In one implementation, the captioning module 109 determines how the video 103A-D is being rendered and can provide custom captioning (e.g., captioning 121A-D) in the media UI 117A-B depending on how the video 103A-D is being rendered. In one implementation, the determination how the video 103A-D is being rendered. One implementation of customizing the captioning in the media UI based on the how the video is being rendered is described in greater detail below in conjunction with FIG. 2. For example, the captioning module 109 may determine that rendering mode 131 is being used and may provide captioning 121A in the media UI 117A, such that the captioning 121A is a layer on top of the video 103A and in a horizontal orientation. In another example, the captioning module 109 may determine that rendering mode 131 is being used and may provide captioning 121B in the media UI 117A, such that the video information 105B is moved down and the captioning 121B is provided below the video 103B. In another example, the captioning module 109 may determine that rendering mode 131 is being used and may provide captioning 121C in the media UI 117A, such that the captioning 121C is a layer on top of the video 103A and in a vertical orientation. In another example, the captioning module 109 may determine that rendering mode 137 is being used and may provide captioning 121D in the media UI 117A, such that the captioning 121D is a layer on top of the video 103D and in a horizontal orientation.

The rendering modes 131,137 can be assigned a corresponding set of captioning parameters. The captioning parameters specify the characteristics of the captioning 121A-D. Examples of captioning parameters can include, and are not limited to, font of the captioning, font size of the captioning, kerning (spacing between characters) of the captioning, position of the captioning, wrapping of the captioning, orientation of the captioning, animation of the captioning, etc. For example, captioning 121D may have a font size that is smaller than captioning 121A,B. In other examples, captioning 121C may be scrolling in a vertical direction, captioning 121A may be scrolling in a horizontal direction, and captioning 121B and captioning 121D may not be scrolling.

FIG. 2 is flow diagram of an implementation of a method 200 for providing custom captioning for a media item in a media user interface based the rendering of the media item. The method may be performed by processing logic that may comprise hardware (circuitry, dedicated logic, etc.), software (such as is run on a general purpose computer system or a dedicated machine), or a combination of both. In one implementation, the method 200 may be performed by the captioning module 109 on a mobile device 100 in FIG. 1. In another implementation, one or more portions of method 200 may be performed by a server computer system coupled to the mobile device over one or more networks.

At block 201, the captioning module determines the rendering mode for a media item being presented (e.g., played) in a media user interface (UI) on a mobile device. The captioning module can determine the rendering mode by determining the orientation (e.g., portrait, landscape) of the mobile device and one or more elements of the media UI on the mobile device. Examples of elements of the media UI can include, and are not limited to, the portion of the media UI that is presenting the media item, a location in the media UI of the portion, dimensions of the media item that is presented, data pertaining to the media item, location in the media UI of the data pertaining to the media item, etc.

In one implementation, there is an application platform that queries the operating system of the mobile device in the background for the orientation of the mobile device and receives the orientation from the operating system. The application platform can store an orientation state, which indicates whether the mobile device is in portrait mode or landscape mode, in a data store. The captioning module can query the application platform for the orientation state and receive a result. In another implementation, the captioning module accesses the stored orientation state in the data store. In another implementation, the captioning module queries the operating system for the orientation of the mobile device and receives a result.

The captioning module can determine the one or more elements of the media UI, for example, from the media consumption document (e.g., webpage, mobile application document) that is rendered to provide the media UI that is presented to a user for presenting (e.g., playing) the media item. The media consumption document can include data that indicates, for example, the portion of the media UI that is presenting the media item, the location in the media UI of the portion, the dimensions of the media item that is presented, the location in the media UI of data (e.g., related videos, number of likes, comments, etc.) pertaining to the media item, the data (e.g., related videos, number of likes, comments, etc.) in the media UI that pertains to the media item, etc. For example, the captioning module may determine that the rendering mode for the media item includes the mobile device being in a portrait orientation, a 30% portion of the media UI is used to play the video, the 30% portion is located in the top portion of the media UI, a 70% portion of the media UI is used to provide video information, and the 70% portion of the media UI is used to provide video information is located at the bottom portion of the media UI.

At block 203, the captioning module determines captioning parameters that correspond to the rendering mode of the media item. Examples of captioning parameters can include, and are not limited to, font of the captioning, font size of the captioning, kerning of the captioning, position of the captioning, wrapping of the captioning, orientation of the captioning, animation of the captioning, etc. In one implementation, the captioning module determines the captioning parameters that correspond to the rendering mode from the media consumption document (e.g., webpage, mobile application document) that is rendered to play the media item. For example, the media consumption document may include code (e.g., IF-THEN statements) indicating which captioning parameters correspond to the rendering mode of the media item. The media consumption document can include multiple IF-THEN statements corresponding to different types of captioning.

For example, the captioning module may determine that when the rendering mode for the media item includes the mobile device being in a portrait orientation, a 30% portion of the media UI is used to play the video, and the 30% portion is located in the top portion of the media UI, the corresponding set of captioning parameters includes Font-XYZ, Font-Size-AB, kerning of X spacing between characters, position Y as a layer on top of the video, wrapping disabled, horizontal orientation, animation enabled as scrolling, etc.

In another implementation, the captioning module determines the captioning parameters that correspond to the rendering mode from a configuration file that is stored in a data store that is coupled to the captioning module. The configuration file can map a set of captioning parameters to a rendering mode. The mapping can be configurable and can be user (e.g., system administrator) defined.

In one implementation, the captioning module sends the rendering mode to a server computer system via one or more networks, and the server determines the captioning parameters that correspond to the rendering mode of the media item. In one implementation, the server computer system provides the captioning parameters that correspond to the rendering mode of the media item to the captioning module.

At block 205, the captioning module provides the captioning for the media item in the media UI based on the set of captioning parameters. In one implementation, the content (e.g., text, characters, symbols, punctuation, pictorial representations, etc.) for the captioning is stored in a data store that is coupled to the captioning module. The content can be pre-determined. The content can be provided by one or more users (e.g., system administrator, end-users) and/or one or more other systems. For example, the content may be a transcription of the audio portion of a video. In another example, the content may be user-defined. For example, the content may include user comments about a video. The user comments may correspond to particular segments of the video.

For example, the captioning module formats the content according to the set of captioning parameters and provides the formatted content in the media UI. For example, the captioning module formats a transcription of Video-ABC using Font-XYZ, Font-Size-AB, kerning of X spacing between characters, position Y as a layer on top of the Video-ABC, wrapping disabled, horizontal orientation, animation enabled as scrolling, etc. In one implementation, the captioning module sends the rendering mode to the server computer system, and the server computer system determines the captioning parameters that correspond to the rendering mode of the media item and creates a document (e.g., webpage) with the appropriate captioning based on the rendering mode. The server computer system can provide the document (e.g., webpage) with the appropriate captioning to the mobile device, and the mobile device renders the document to present the media item with the appropriate captioning to the user.

At block 207, the captioning module determines whether the rendering mode has changed. For example, the captioning module may receive an event notification from the media application. The change can be based on the orientation of the mobile device and/or user input pertaining to how the video is to be played. For example, the captioning module may determine that the mobile device is changed from being in a first orientation to a second orientation. For example, the captioning module may determine that the mobile device is changed from being in a portrait orientation to a landscape orientation. In another example, the captioning module may determine that the mobile device is changed from being in a landscape orientation to a portrait orientation.

In another example, the captioning module may receive user input changing one of the elements of the user interface. For example, a user may initially view a video using a first rendering mode (e.g., rendering mode 131 in FIG. 1), and the user may provide input to the captioning module to change the playing of the video to use a second rendering mode (e.g., rendering mode 137 in FIG. 1). For example, the first rendering mode may play the video in a portrait orientation using the top 30% portion of the display of the mobile device, and the second rendering mode may play the video in the portrait orientation using 15% (e.g., bottom right corner) of the display of the mobile device. In one implementation, the orientation of the mobile device does not change, but an element (e.g., portion, location, etc.) in the media UI changes.

If the rendering mode has not changed (block 207), the captioning module determines whether the presentation (e.g., playing) of the media item is complete at block 213. The captioning module may receive an event notification, for example, from the media application. If the presentation of the media item is not complete, the captioning module returns to block 207 to determine whether the rendering mode has changed. If the rendering mode has changed (block 207), the captioning module determines the set of captioning parameters that corresponds to the changed rendering mode at block 209. The captioning module can identify the changed rendering mode and can identify the set of captioning parameters that corresponds to the changed rendering mode. For example, the captioning module may determine that the set of captioning parameters for the changed rendering mode includes using Font-123, Font-Size-00, kerning of ZZ spacing between characters, position YY as a layer on top of the video, wrapping disabled, horizontal orientation, animation disabled, etc. At block 211, the captioning module provides the captioning for the media item in the media UI based on the set of captioning parameters for the changed rendering mode. For example, the captioning module adjusts the existing captioning and/or creates new captioning to conform to Font-123, Font-Size-00, kerning of ZZ spacing between characters, position YY as a layer on top of the video, wrapping disabled, horizontal orientation, animation disabled, etc. In one implementation, the captioning module sends data to the server computer system indicating the changed rendering mode, the server computer system creates a document (e.g., webpage) with appropriate captioning based on the changed rendering mode and sends the document to the mobile device. The mobile device can render the document to present the media item with the appropriate captioning to the user.

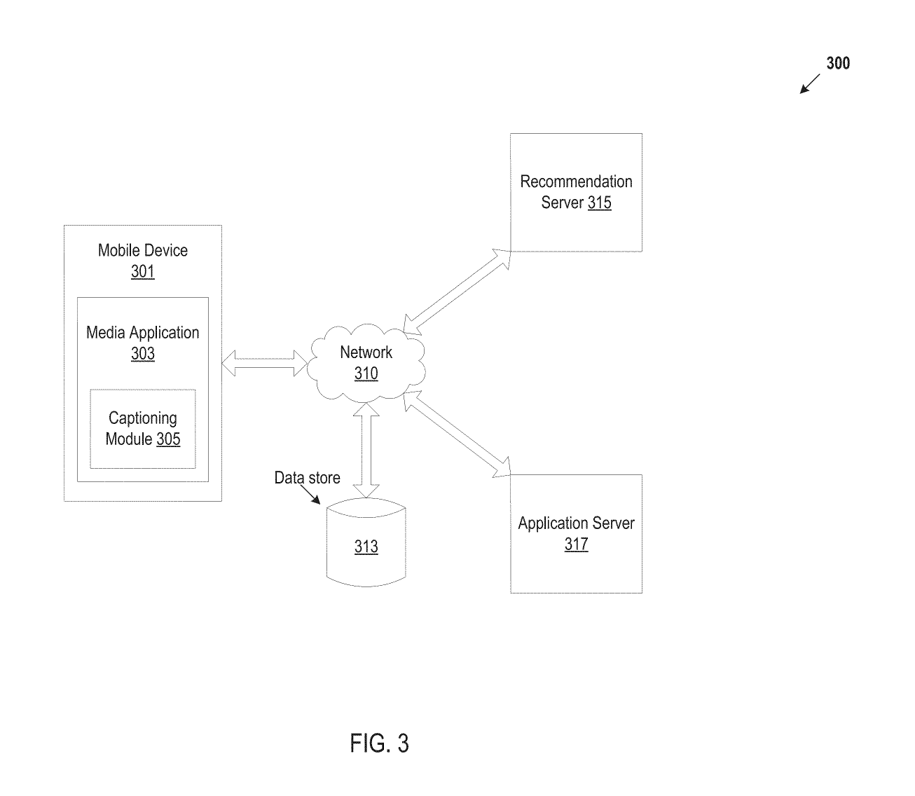

FIG. 3 illustrates exemplary system architecture 300 in which implementations can be implemented. The system architecture 300 can include one or more mobile devices 301, one or more servers 315,317, and one or more data stores 313 coupled to each other over one or more networks 310. The network 310 may be public networks (e.g., the Internet), private networks (e.g., a local area network (LAN) or wide area network (WAN)), or a combination thereof.

The data stores 313 can store media items, such as, and not limited to, digital video, digital movies, digital photos, digital music, website content, social media updates, electronic books (ebooks), electronic magazines, digital newspapers, digital audio books, electronic journals, web blogs, real simple syndication (RSS) feeds, electronic comic books, software applications, etc. A data store 313 can be a persistent storage that is capable of storing data. As will be appreciated by those skilled in the art, in some implementations data store 313 might be a network-attached file server, while in other implementations data store 313 might be some other type of persistent storage such as an object-oriented database, a relational database, and so forth.

The mobile devices 301 can be portable computing devices such as a cellular telephones, personal digital assistants (PDAs), portable media players, netbooks, laptop computers, an electronic book reader or a tablet computer (e.g., that includes a book reader application), a set-top box, a gaming console, a television, and the like.

The mobile devices 301 can run an operating system (OS) that manages hardware and software of the mobile devices 301. A media application 303 can run on the mobile devices 301 (e.g., on the OS of the mobile devices). For example, the media application 303 may be a web browser that can access content served by an application server 317 (e.g., web server). In another example, the mobile application 303 may be an application that can access content served by an application server 317 (e.g., mobile application server).

The application server 317 can provide web applications and/or mobile device applications and data for the applications. The recommendation server 315 can provide media items (e.g., videos) that are related to other media items. The sets of related media items can be stored on one or more data stores 313. The servers 315,317 can be hosted on machines, such as, and not limited to, rackmount servers, personal computers, desktop computers, media centers, or any combination of the above.

The captioning module 305 can provide custom captioning for a media item in media user interfaces based on how the media item is being rendered. For example, Video-XYZ may be playing using a rendering mode that includes the mobile device 301 being in a landscape orientation and use of a large (e.g., 95%) portion of the display of the media device. The captioning module 205 can provide captioning for Video-XYZ according to a set of captioning parameters that corresponds to the rendering mode. For example, the captioning module 305 may format a transcription of the audio of Video-XYZ using Font-Type-1, Font-Size-3, kerning of XYZ spacing between characters, position ABC as a layer on top of the video, wrapping enabled, horizontal orientation, animation disabled, etc. The captioning module 305 can detect that the rendering mode has changed and can dynamically adjust the captioning and/or create new captioning based on the changed rendering mode. For example, the rendering mode may include the mobile device being in a portrait orientation, and the captioning module 305 may decrease the font size of the captioning, may decrease the kerning spacing between characters of the captioning, etc. to adjust for a smaller layout that is associated with the portrait orientation.

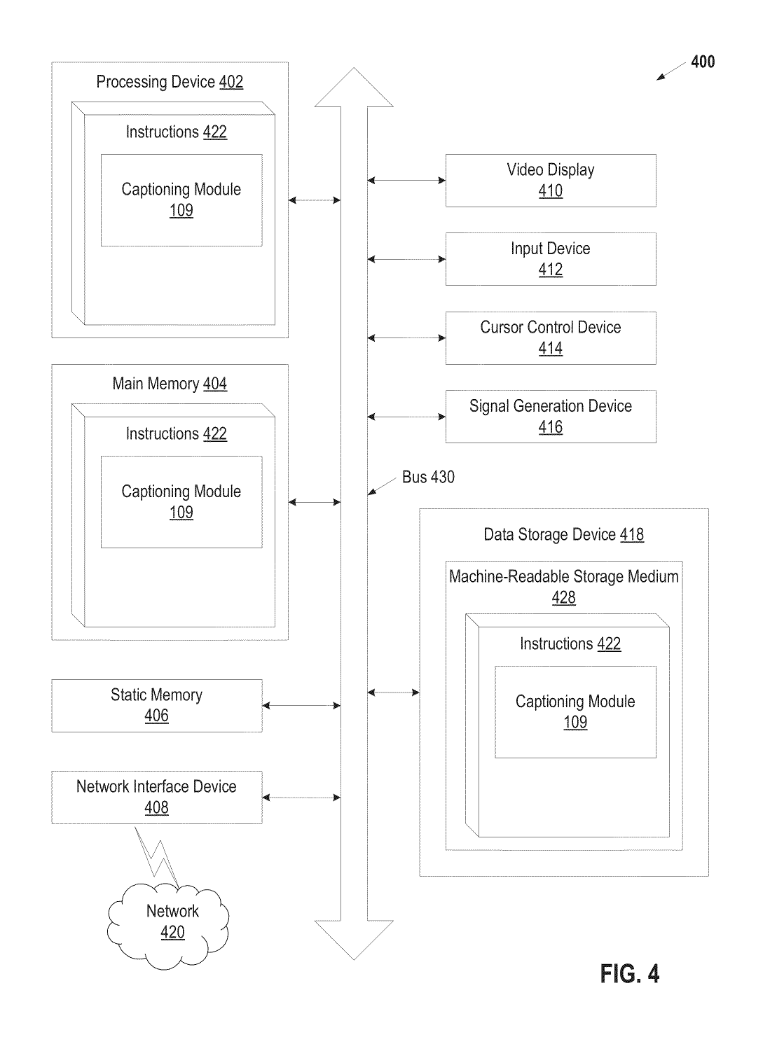

FIG. 4 illustrates a diagram of a machine in an example form of a computer system 400 within which a set of instructions, for causing the machine to perform any one or more of the methodologies discussed herein, may be executed. The computer system 400 can be mobile device 100 in FIG. 1. In alternative implementations, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processing device (processor) 402, a main memory 404 (e.g., read-only memory (ROM), flash memory, dynamic random access memory (DRAM) such as synchronous DRAM (SDRAM), double data rate (DDR SDRAM), or DRAM (RDRAM), etc.), a static memory 406 (e.g., flash memory, static random access memory (SRAM), etc.), and a data storage device 418, which communicate with each other via a bus 430.

Processor 402 represents one or more general-purpose processing devices such as a microprocessor, central processing unit, or the like. More particularly, the processor 402 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 402 may also be one or more special-purpose processing devices such as an application specific integrated circuit (ASIC), a field programmable gate array (FPGA), a digital signal processor (DSP), network processor, or the like. The processor 402 is configured to execute instructions 422 for performing the operations and steps discussed herein.

The computer system 400 may further include a network interface device 408. The computer system 400 also may include a video display unit 410 (e.g., a liquid crystal display (LCD) or a cathode ray tube (CRT)), an input device 412 (e.g., a keyboard, and alphanumeric keyboard, a motion sensing input device,), a cursor control device 414 (e.g., a mouse), and a signal generation device 416 (e.g., a speaker).

The data storage device 418 may include a computer-readable storage medium 428 on which is stored one or more sets of instructions 422 (e.g., software) embodying any one or more of the methodologies or functions described herein. The instructions 422 may also reside, completely or at least partially, within the main memory 404 and/or within the processor 402 during execution thereof by the computer system 400, the main memory 404 and the processor 402 also constituting computer-readable storage media. The instructions 422 may further be transmitted or received over a network 420 via the network interface device 408.

In one implementation, the instructions 422 include instructions for a captioning module (e.g., captioning module 109 in FIG. 1) and/or a software library containing methods that call the captioning module. While the computer-readable storage medium 428 (machine-readable storage medium) is shown in an exemplary implementation to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “determining”, “providing”, “populating”, “changing”, “detecting”, “modifying”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

For simplicity of explanation, the methods are depicted and described herein as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

Certain implementations of the present disclosure also relate to an apparatus for performing the operations herein. This apparatus may be constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

Reference throughout this specification to “one implementation” or “an implementation” means that a particular feature, structure, or characteristic described in connection with the implementation is included in at least one implementation. Thus, the appearances of the phrase “in one implementation” or “in an implementation” in various places throughout this specification are not necessarily all referring to the same implementation. In addition, the term “or” is intended to mean an inclusive “or” rather than an exclusive “or.” Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
determining a rendering mode for a media item presented in a user interface on a mobile device, wherein the rendering mode is one of a plurality of rendering modes;
determining, by a processing device, one of a plurality of sets of captioning parameters that corresponds to the rendering mode of the media item; and
providing captioning for the media item in the user interface based on the one of the plurality of sets of captioning parameters that corresponds to the rendering mode.

2. The method of claim 1, wherein the plurality of captioning parameters comprises at least one of font of the captioning, font size of the captioning, kerning of the captioning, position of the captioning, wrapping of the captioning, orientation of the captioning, or animation of the captioning.

3. The method of claim 1, wherein determining the rendering mode for the media item comprises:
determining an orientation of the mobile device; and
determining one or more elements of the user interface on the mobile device.

4. The method of claim 3, wherein the one or more elements of the user interface comprises at least one of a portion of the user interface that is presenting the media item, a location in the user interface of the portion, dimensions of the media item that is presented, or data pertaining to the media item.

5. The method of claim 1, further comprising:
determining a change is made to the rendering mode to create a changed rendering mode;
determining another one of the plurality of sets of captioning parameters that corresponds to the changed rendering mode; and
adjusting the captioning for the media item in the user interface based on the other one of the plurality of sets of captioning parameters that corresponds to the rendering mode.

6. The method of claim 5, wherein determining the change comprises at least one of:
determining that the mobile device is changed from being in a first orientation to a second orientation, or
receiving user input changing one of the elements of the user interface.

7. The method of claim 1, wherein the rendering mode comprises the mobile device being in a portrait orientation and the media item being presented in a lower portion of a display of the mobile device in the portrait orientation.

8. An apparatus comprising:
a memory; and
a processing device coupled with the memory to:
determine a rendering mode for a media item presented in a user interface on a mobile device, wherein the rendering mode is one of a plurality of rendering modes;
determine one of a plurality of sets of captioning parameters that corresponds to the rendering mode of the media item; and
provide captioning for the media item in the user interface based on the one of the plurality of sets of captioning parameters that corresponds to the rendering mode.

9. The apparatus of claim 8, wherein the plurality of captioning parameters comprises at least one of font of the captioning, font size of the captioning, kerning of the captioning, position of the captioning, wrapping of the captioning, orientation of the captioning, or animation of the captioning.

10. The apparatus of claim 8, wherein to determine the rendering mode for the media item comprises the processing device to:
determine an orientation of the mobile device; and
determine one or more elements of the user interface on the mobile device.

11. The apparatus of claim 10, wherein the one or more elements of the user interface comprises at least one of a portion of the user interface that is presenting the media item, a location in the user interface of the portion, dimensions of the media item that is presented, or data pertaining to the media item.

12. The apparatus of claim 8, wherein the processing device is further to:
determine a change is made to the rendering mode to create a changed rendering mode;
determine another one of the plurality of sets of captioning parameters that corresponds to the changed rendering mode; and
adjust the captioning for the media item in the user interface based on the other one of the plurality of sets of captioning parameters that corresponds to the rendering mode.

13. The apparatus of claim 12, wherein to determine the change comprises the processing device to at least one of:
determine that the mobile device is changed from being in a first orientation to a second orientation, or
receive user input changing one of the elements of the user interface.

14. The apparatus of claim 8, wherein the rendering mode comprises the mobile device being in a portrait orientation and the media item being presented in a lower portion of a display of the mobile device in the portrait orientation.

15. A non-transitory computer readable storage medium encoding instructions thereon that, in response to execution by a processing device, cause the processing device to perform operations comprising:
determining a rendering mode for a media item presented in a user interface on a mobile device, wherein the rendering mode is one of a plurality of rendering modes;
determining, by the processing device, one of a plurality of sets of captioning parameters that corresponds to the rendering mode of the media item; and
providing captioning for the media item in the user interface based on the one of the plurality of sets of captioning parameters that corresponds to the rendering mode.

16. The non-transitory computer readable storage medium of claim 15, wherein the plurality of captioning parameters comprises at least one of font of the captioning, font size of the captioning, kerning of the captioning, position of the captioning, wrapping of the captioning, orientation of the captioning, or animation of the captioning.

17. The non-transitory computer readable storage medium of claim 15, wherein determining the rendering mode for the media item comprises:
determining an orientation of the mobile device; and
determining one or more elements of the user interface on the mobile device.

18. The non-transitory computer readable storage medium of claim 17, wherein the one or more elements of the user interface comprises at least one of a portion of the user interface that is presenting the media item, a location in the user interface of the portion, dimensions of the media item that is presented, or data pertaining to the media item.

19. The non-transitory computer readable storage medium of claim 15, the operations further comprising:
determining a change is made to the rendering mode to create a changed rendering mode;
determining another one of the plurality of sets of captioning parameters that corresponds to the changed rendering mode; and
adjusting the captioning for the media item in the user interface based on the other one of the plurality of sets of captioning parameters that corresponds to the rendering mode.

20. The non-transitory computer readable storage medium of claim 15, wherein the rendering mode comprises the mobile device being in a portrait orientation and the media item being presented in a lower portion of a display of the mobile device in the portrait orientation.

21. A computer-implemented method comprising:
detecting a change in a rendering mode of a media item presented in a user interface on a mobile device, wherein the rendering mode is one of a plurality of rendering modes; and
modifying, in the user interface, captioning for the media item in accordance with the changed rendering mode.
